(19) United States
(12) Patent Application Publication
(10) Pub. No.: US 2025/0030289 A1
(43) Pub. Date: Jan. 23, 2025

(54) ROTOR FOR AN EXTERNAL ROTOR MOTOR

(71) Applicant: BorgWarner Inc., Auburn Hills, MI (US)

(72) Inventors: Silvio Koch, Kirchheimbolanden (DE); Thomas Ramb, Worms (DE); Dietmar Metz, Meckenheim (DE)

(21) Appl. No.: 18/765,971

(22) Filed: Jul. 8, 2024

(30) Foreign Application Priority Data
Jul. 21, 2023 (DE) DE102023119401.1

(51) Int. Cl. H02K 1/30; H02K 1/2791

(52) U.S. Cl. CPC H02K 1/30; H02K 1/2791

(57) ABSTRACT

A rotor for an external rotor motor is described, comprising a stack of annular sheets made of steel, permanent magnets which are attached to an inner side of the stack of sheets, and a carrier which has a hub for a shaft and is attached to the stack of sheets. Tie rods are provided which project in the axial direction through the carrier and the stack of sheets and pull the stack of sheets against the carrier.

### CROSS REFERENCE TO RELATED APPLICATIONS

This application claims the priority to German Patent Application No. DE102023119401.1 filed on Jul. 21, 2023, and the entire content of this priority application is incorporated herein by reference in its entirety.

### TECHNICAL FIELD

The disclosure is based on a rotor for an electric motor.

### BACKGROUND

In a rotor for an external rotor motor, the back iron ring formed by a stack of sheets made of ferromagnetic material, e.g. steel, must be connected to a carrier that has a hub for a shaft. During operation, this connection must be able to transfer considerable torque from the stack of sheets to the carrier and also prevent axial movement of the stack of sheets relative to the carrier.

An object of at least some implementations of the disclosure is to show how this can be done reliably and cost-effectively.

### SUMMARY

A rotor may have tie rods which protrude through the carrier and the stack of sheets in the axial direction and pull the stack of sheets against the carrier. Suitable openings for the tie rods can be created when the individual sheets are punched out at no additional cost. The tie rods can be designed as pins which protrude through these openings in the sheets and matching openings in the carrier and have an end piece at at least one end which is wider than the channel formed by the openings. End pieces may, for example, be attached to the pins by rivets. Such rivets may be integral to the tie rod, i.e. suitably formed end of the tie rods, or separate rivets. End pieces may also be designed as removable end pieces. One possibility for this is that the end pieces are screwed onto matching threads on the pins, for example as nuts. Another possibility is to form the removable end pieces as clips or clamps.

The tie rods can be designed as pins that have removable end pieces at both ends. However, it is also possible for the pins to have a removable end piece at only one of their ends and to have a head at their other end that is wider than the channel formed by the openings of the plates and the support.

An advantageous refinement of the disclosure provides for the stack of sheets to have an end ring at its end facing away from the carrier, which may have an axial stop for the permanent magnets, and the tie rods also project through the end ring. In this way, the permanent magnets arranged on the inside of the stack of sheets can be easily secured against axial movement.

A further refinement of the disclosure provides that the openings in the metal sheets through which the tie rods protrude each have a round main area and a slot extending from the main area. The tie rod essentially fills this main area completely. The round main area may, for example, be a circular surface or have a slightly different shape. A slot extending from this main area can advantageously prevent the tie rod from turning during the screwing on of an end piece, for example by a nose of a head of the tie rod engaging in the slot.

The slot may, for example, have a length that is between half and the whole width of the main area of the opening, i.e. between the radius and the diameter in the case of a circular main area. The width of the slot can, for example, be between 20% and 40% of the width of the main area of the opening, i.e. between 10% and 40% of the diameter of the main area in the case of a circular main area.

### BRIEF DESCRIPTION OF THE DRAWINGS

Further details and advantages of the disclosure are explained with reference to an embodiment of the disclosure with reference to the accompanying drawings.

FIG. 1 shows a rotor for an external rotor motor;

FIG. 2 shows a sectional detail view of the rotor; and

FIGS. 3A, 3B, 3C, 3D and 3E show a detailed view of components of the rotor.

### DETAILED DESCRIPTION

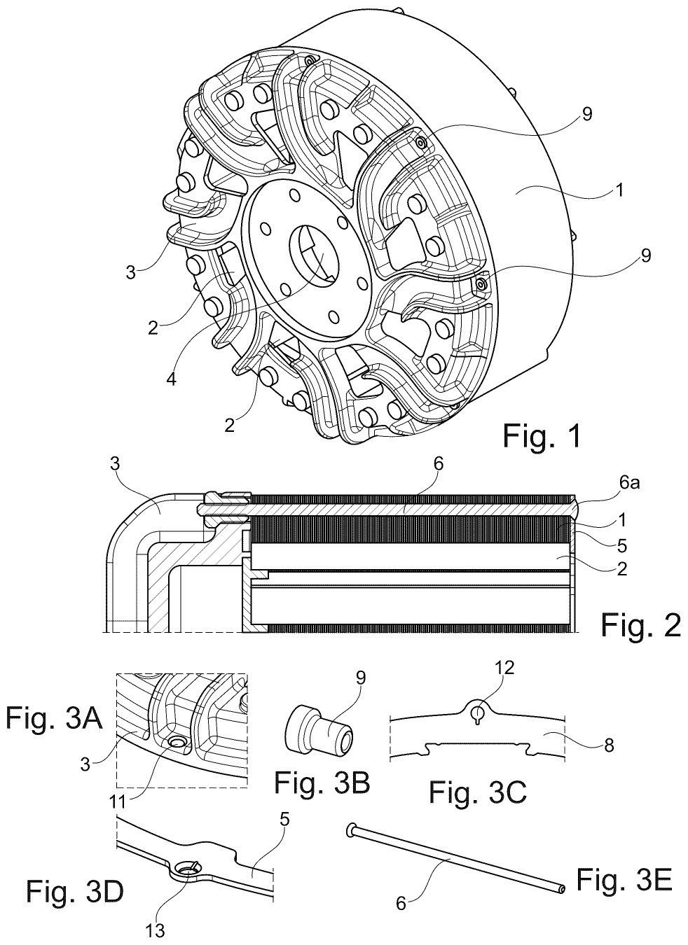

FIG. 1 shows a rotor for an electric motor, more specifically an external rotor motor. The rotor comprises a stack 1 of annular ferromagnetic steel sheets, permanent magnets 2 attached to an inner side of the stack 1, and a carrier 3 attached to the stack 1, which has a hub 4 for a shaft not shown. The carrier 3 may be made of aluminum or an aluminum-based alloy, for example. The sheets of the stack 1 are made of electro-steel, i.e. soft magnetic steel, for example silicon steel, and are stacked on top of each other in the axial direction. The sheet plane of the individual sheets therefore extends perpendicular to the axial direction.

The individual sheets of the stack of sheets 1 may be ring-shaped sheets or form only one ring segment each.

At its end facing away from the support 3, the stack of sheets 1 may carry an end ring 5, which forms an axial stop for the permanent magnets 2 and secures the permanent magnets 2 against axial movement.

The permanent magnets 2 may, for example, be made of a material based on Nd₂Fe₁₄B and be attached to the stack of sheets 1 by means of an adhesive, which may be in grooves on the inside of the stack of sheets 1. Another possibility is that the permanent magnets 2 are attached to the stack of sheets 1 in a clamping manner.

The stack of sheets 1, the support 3 and the end ring 5 are connected by tie rods 6, which are shown in the sectional view in FIG. 2 and project axially through the support 3, the stack of sheets 1 and the end ring 5. The tie rods 6 pull the stack of sheets 1 against the carrier 3 and fix the stack of sheets 1, carrier 3 and the end ring 5 to each other.

The tie rods 6 are designed as pins, each of which is arranged in a channel running through the stack of sheets 1 and the support 3 and has a removable end piece 9 at at least one end, which is wider than the channel. The end piece 9 can, for example, be screwed onto a thread of the tie rod 6. Corresponding end pieces 9 may be attached to both ends of the tie rods 6. In the embodiment shown, the tie rod 6 only has a removable end piece 9 at one end. At its other end, it has a widened head 6a, which is wider than the channel.

The channel is formed by aligned openings 11, 12, 13 in the support 3, in the stack of sheets 1 and in the end ring 5, which may be seen in FIG. 3.

FIGS. 3A, 3B, 3C, 3D and 3E show components of the rotor, namely a detail of one of the ring-shaped sheets 8 forming the stack of sheets 1, a detail of the carrier 3, a detail of the end ring 5, and a tie rod 6 with a removable end piece 9.

The openings 12 in the stack of sheets 1 and the openings 13 in the end ring 5 have a substantially circular main area, from which a radially inwardly directed slot extends. This slot may, for example, have a width of between a quarter and a half of the diameter of the main area, which may be 15% to 30%, and a length of between a third and a half of the diameter of the main area. A lug of the head 6a can engage in this slot during assembly and thus prevent the tie rod 6 from rotating when an end piece 9 is screwed on.

1. A rotor for an external rotor motor, comprising
a stack of ring-shaped steel sheets,
permanent magnets fixed to an inner side of the stack of sheets, and
a carrier which has a hub for a shaft and is fastened to the stack of sheets, wherein tie rods, which project axially through the carrier and the stack of sheets and pull the stack of sheets against the carrier.

2. The rotor according to claim 1, wherein the tie rods are designed as pins, which are each arranged in a channel leading through the stack of sheets and the carrier and carry an end piece at at least one end, which has a greater width than the channel.

3. The rotor according to claim 2, wherein the end piece is removable.

4. The rotor according to claim 2, wherein the pins carry a removable end piece at both ends.

5. The rotor according to claim 2, wherein the pins have a widened head at one end, which has a greater width than the channel.

6. The rotor according to claim 3, wherein the tie rods are threaded pins and the end pieces are screwed onto the pins.

7. The rotor according to claim 1, wherein the stack of sheets carries an end ring at its end facing away from the carrier, which end ring forms an axial stop for the permanent magnets, and the tie rods also project through the end ring.

8. The rotor according to claim 1, wherein the stack of sheets is formed from sheets which have a plurality of openings for the tie rods, the openings each having a round main area and a slot extending from the main area.

9. The rotor according to claim 8, wherein the slot is directed radially inwards.
